(19) United States
(12) Patent Application Publication
(10) Pub. No.: US 2023/0169191 A1
(43) Pub. Date: Jun. 1, 2023

(54) SYSTEM AND METHOD FOR DETECTING URLS USING RENDERED CONTENT MACHINE LEARNING

(71) Applicant: UAB 360 IT, Vilnius (LT)

(72) Inventor: Margarita Sliachina, Vilnius (LT)

(21) Appl. No.: 17/539,354

(22) Filed: Dec. 1, 2021

(51) Int. Cl. G06F 21/60

(52) U.S. Cl. CPC G06F 21/604; H04L 63/1483; G06F 2221/2141

(57) ABSTRACT

A system, apparatus and method for detecting uniform resource locators (URLs) of undesirable web pages comprising identifying a web page having an associated URL, rendering the content of the web page and logging the URL associated with the web page. The rendered content is analyzed by applying a machine learning algorithm comprising a neural network, where the neural network analyzes the rendered content to identify undesirable attributes within the rendered content. Upon identifying undesirable content, the URL is stored in a database for subsequent use by user devices to control access to the URL and its associated web page.

### FIELD

The present invention relates generally to website content display control, and more particularly to detecting URLs using rendered content machine learning such that content display is controlled for content located at the detected URLs.

### BACKGROUND

Uniform Resource Locators (URLs) are used by web browsers to locate and display content of web resources (e.g., web pages) to internet users. Although URLs are indispensable for locating and displaying content, they can also be used to display undesirable (e.g., unwanted and/or malicious) content (e.g., advertisements, phishing content, malware, etc.). To stop the display or access to undesirable content a user can manually request a browser to block specific URLs from being accessed. Also, services may be used that generate block lists, mostly via complaining internet users and/or manual entering of known malicious URLs, to block certain URLs from being accessible to the users of the service. The process for generating block lists is time consuming and may overlook malicious resources that result in security breaches and information leaks.

Therefore, there is a need for improved methods and systems for detecting URLs that are to be blocked or otherwise controlled using rendered content machine learning.

### SUMMARY

A system, apparatus and method for detecting uniform resource locators (URLs) of undesirable web pages comprising identifying a web page having an associated URL, rendering the content of the web page and logging the URL associated with the web page. The rendered content is analyzed by applying a machine learning algorithm comprising a neural network, where the neural network analyzes the rendered content to identify undesirable attributes within the rendered content. Upon identifying undesirable content, the URL is stored in a database for subsequent use by user devices to control access to the URL and its associated web page.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 illustrates an example of a system for detecting URLs using rendered content machine learning in accordance with an embodiment of the present principles.

FIG. 2 depicts a flow diagram of a method for detecting URLs using rendered content machine learning, in accordance with an embodiment of the present principles.

FIG. 3 depicts a flow diagram of a method for utilizing the detected URLs of FIG. 2, in accordance with an embodiment of the present principles.

FIG. 4 depicts a block diagram of a distributed system for detecting URLs using rendered content machine learning, in accordance with an embodiment of the present principles.

FIG. 5 depicts a high-level block diagram of a computing device suitable for use with embodiments of a system for detecting URLs using rendered content machine learning in accordance with the present principles.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

The following detailed description describes techniques (e.g., methods, processes, apparatuses and systems) for detecting URLs using rendered content machine learning. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

Embodiments consistent with the present invention detect URLs using rendered content machine learning. In some embodiments, the detected URLs are used to establish rules to control access to the detected URLs, e.g., block access to the URL. In one embodiment, the detected URLs that are indicated as containing undesirable content are transmitted to an application (client application) executing on a user's device. The application controls access to the identified URLs such that, for example, the user device does not access the content at the identified URLs.

In some embodiments, the URLs are identified through access and rendering of web content using a web crawler. Web crawlers are internet bots that systematically browse the internet and are typically operated by search engines to index the internet. The use of web crawlers is well known for internet indexing, i.e., identifying new URLs, updated content at URLs, unused URLs, and the like. To identify URLs, some embodiments of the invention use a web crawler to systematically browse the internet. A server application operates the web crawler to render the content at each accessed URL. At each rendered web page, a machine learning (ML) algorithm analyzes the rendered content to detect specific undesirable attributes of the content that indicate undesirable content. Undesirable content is content that a user would deem unimportant and/or would cause harm to their user device (e.g., malware, viruses, etc.) Initially, the ML algorithm identifies traditionally undesirable content such as known malware, known viruses, known phishing content, certain types of advertising that a typical user would not desire to view, etc. As the ML algorithm is used, a user's personal view of “undesirable” is learned such that specific content that is undesirable to a particular user is identified, e.g., specific advertisements, pornography, phishing content, etc. URLs associated with advertisements are typically identified by containing dynamic content. In addition, the ML algorithm may identify content that contains non-essential elements, i.e., content elements that are not necessary to render the content. These non-essential elements may contain viruses or malware. Such undesirable content may be deemed advertising and/or malicious and indicate a URL worthy of controlling (e.g., blocking). The identified URL may then be added to a block list on the server, sent to a block list on a user device or handled in some specific manner for the type of content, i.e., handling rules are applied to the identified URL.

In an embodiment where a web crawler is not used, an application on a user device may render content of visited web locations and, use a machine learning algorithm to identify undesirable content associated with specific URLs. Such URLs may be sent to a server for dissemination to other user devices for use in their block lists or the user device may disseminate the URLs directly to other user devices. In this manner, the search and identification of undesirable URLs is distributed and democratized across a user base.

Thus, systems, apparatuses and methods consistent with embodiments of this present invention detect URLs using rendered content machine learning. Such detected URLs may be handled according to various rules, e.g., allow the URL, block the URL, report the URL, allow the URL only upon user authorization, etc. Details of such systems, apparatuses and methods are described in detail below with respect to the figures.

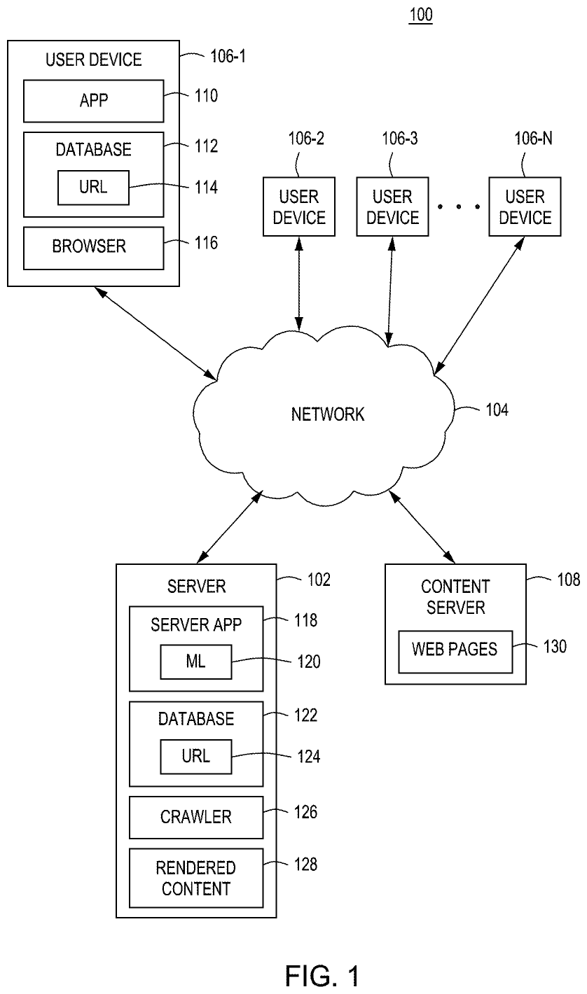

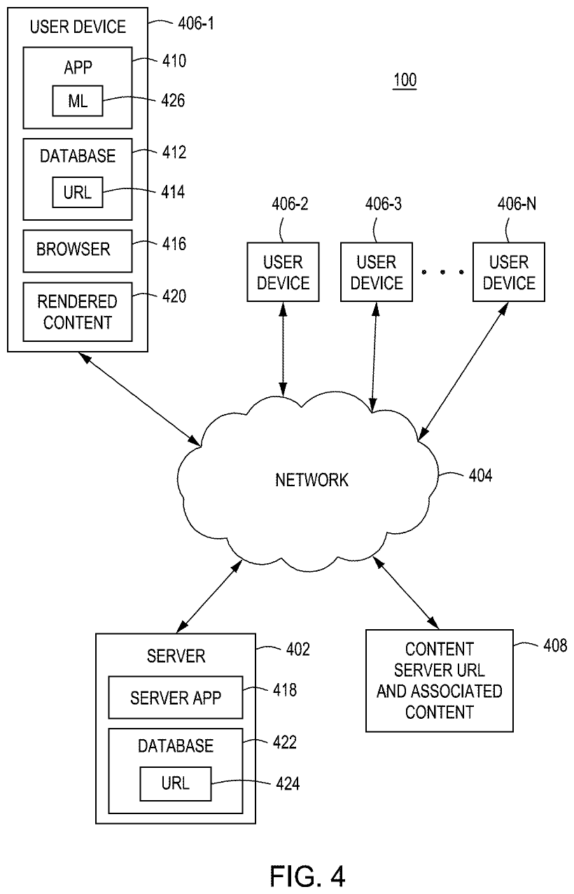

FIG. 1 illustrates an example of a system 100 for detecting URLs using rendered content machine learning in accordance with at least one embodiment of the invention. In this embodiment (a centralized system), a centralized server 102 executes application software 118 (server app) to render web page content and utilize a machine learning (ML) algorithm 120 to analyze the rendered content. In other embodiments (a distributed system, see FIG. 4 and description), user devices execute application software to perform the content rendering and analysis functions.

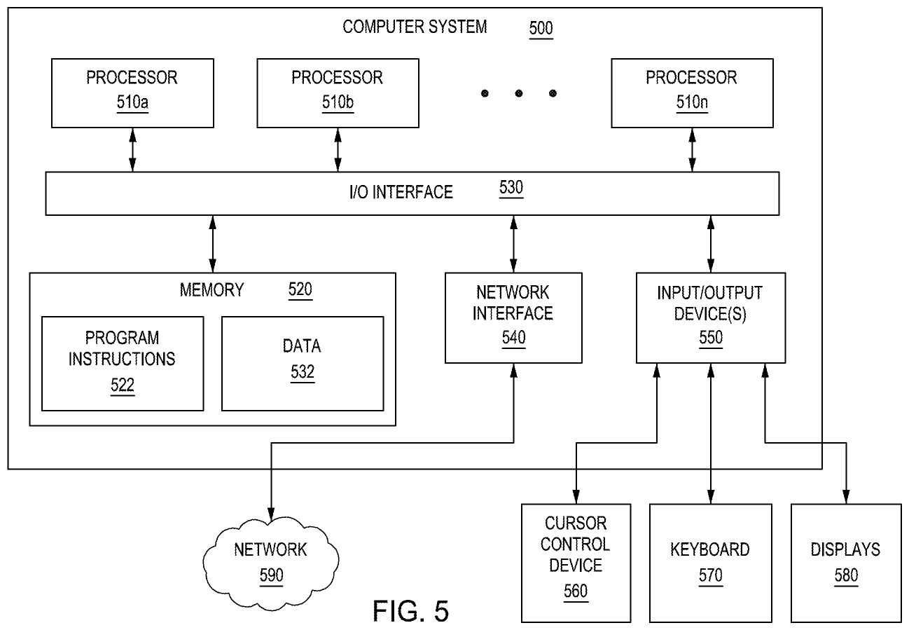

In FIG. 1, the system 100 comprises a server 102, user devices 106, and a computer network 104, e.g., the internet) connecting the server 102 to the user devices 106. The server 102 is a centralized computing device used to execute application(s), access databases, and perform functions to support embodiments of the invention as described herein. The general structure of such a server is described in detail below with respect to FIG. 5.

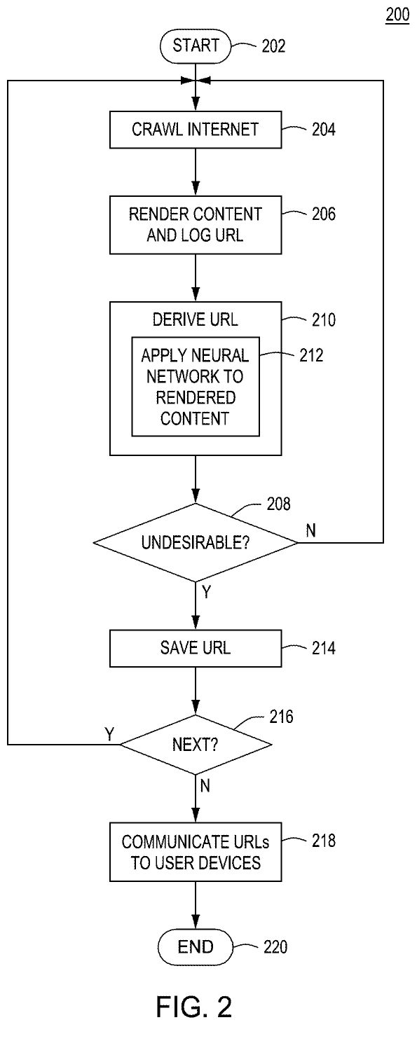

In one embodiment, the server 102 comprises a server application 118, a database 122, a web crawler 126 and rendered content 128. In operation, the server 102 executes the server application 118 to utilize a machine learning algorithm 120 for analyzing the rendered content 128. As described in detail below with respect to FIG. 2, the server application 118 uses a web crawler 126 to access the internet 104 (e.g., access content servers such as content server 108 to access web pages 130). The server application 118 renders the content of each web page 130 identified by the crawler 126 to produce rendered content 128. The server application 118 also temporarily stores (logs) the URL associated with the rendered content. The web crawler identifies the URL associated with the content. Such rendered content 128 may be stored in memory of the server while the content is being analyzed. The server 102 utilizes the machine learning algorithm 120 to analyze the rendered content and determine whether the content is undesirable, e.g., should be blocked or otherwise specially handled. The details of this operation are described with reference to FIG. 2. Suffice it to say, the algorithm 120 analyzes the content and determines which URL is associated with content that requires special handling, e.g., filtering. Such identified URLs may be associated with undesirable content that a user device should not freely access. The identified URLs 124 are stored in a database (DB) 122.

In the centralized embodiment of the invention, the identified URLs 124 are transmitted (pushed or pulled) to user devices 106-1, 106-2, 106-3 . . . 106-N (collectively referred to as user devices 106). In some embodiments, user device 106 can be any computing device capable of hosting a URL access control client application 110. User device 106 can comprise any device that is connected to a network, including, for example, a laptop, a mobile phone, a tablet computer, a desktop computer, a smart device, a router and other network devices. Each user device 106 comprises URL access control application software (app) 110, a database 112 and a browser 116. The browser 116 is a well known application for accessing and displaying web page content. Such browsers include, but are not limited to, Safari®, Chrome®, Explorer®, Firefox®, etc.

The URLs 124 from the server are sent to the user device 106 and stored in a database 112 containing URLs 114. The application 110 (a URL access control application) may be a plug-in, script, independent, or other form of application software that interacts with the browser 116. When the browser 116 is about to access content at a URL in the database 112 the URLs 114 are handled according to a particular rule or rules established by the application 110. For example, the application 110 may filter the URLs, e.g., block the URLs 114. In other cases, the URL may be initially blocked, but the user is asked if they wish the content to be displayed or not. In another case, the URL may be associated with content that is so malicious (e.g., malware or virus) that the application 110 not only blocks the access, but also reports the attempted access to anti-malware or anti-virus applications or services to sweep the user device to ensure the malware was completely blocked.

FIG. 2 illustrates an example flow diagram representing one or more of the processes as described herein. Each block of the flow diagram may represent a module of code to execute and/or combinations of hardware and/or software configured to perform one or more processes described herein. Though illustrated in a particular order, the following figures are not meant to be so limiting. Any number of blocks may proceed in any order (including being omitted) and/or substantially simultaneously (i.e., within technical tolerances of processors, etc.) to perform the operations described herein.

FIG. 2 a flow diagram of a method 200 for detecting URLs using rendered content machine learning, in accordance with an embodiment of the present principles. In some embodiments, the method 200 begins at 202 and proceeds to 204 where a web crawler is used to crawl the internet. At 206, the content of a web page encountered by the crawler is rendered and the URL for the content is logged (temporarily stored). A single web page may have many content elements and each element may have its own related URL, e.g., an advertisement video may be embedded on a page in a separate content window.

At 210, the method 200 analyzes the web page content by applying the machine learning algorithm (e.g., ML algorithm 120) at 212. The ML algorithm is a multi-layer neural network comprising nodes that are trained to have specific weights and biases. In some embodiments, the ML algorithm 120 employs artificial intelligence techniques or machine learning techniques to analyze web page content. In some embodiments, in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Se2oSeq’ Recurrent Neural Network (RNNs)/Long Short Term Memory (LSTM) networks, Convolution Neural Networks (CNNs), graph neural networks applied to the abstract syntax trees corresponding to the sequential program application, and the like. In some embodiments a supervised ML classifier could be used such as, but not limited to, Multilayer Perceptron, Random Forest, Naive Bayes, Support Vector Machine, Logistic Regression and the like.

The ML algorithm is trained using millions of instances of rendered web page content that results in undesirable and desirable content decisions. The training teaches the ML algorithm what content an average user finds undesirable. Over time, the ML algorithm learns to look for specific attributes in the content, determine which content is undesirable to a particular user. The ML algorithm applies one or more criterion (rules) to the content to decide if it is undesirable. Such criteria may include, for example, whether the content is static or dynamic, whether a malicious attribute in the content is apparent, etc. Static content is generally never problematic and will be deemed desirable. For example, undesirable dynamic content may contain unwanted advertisements. The criterion may be established by a user requesting certain types of content be blocked, e.g., pornography, advertisements, specific products, political content, etc. If the rendered content contains any of the requested content, the method 200 deems the criterion met. If the one or more criteria are met, the method proceeds from 212 to 208.

At 208, the method 200 queries whether the machine learning algorithm deems the content undesirable. If the query is negatively answered, the method 200 may flush the previously analyzed rendered content from memory or write over the prior content with new content and proceed to 204 to crawl to the next URL and render additional content. If the query at 208 is affirmatively answered, the method 200 proceeds to 214 to save the logged URL in the database of undesirable URLs.

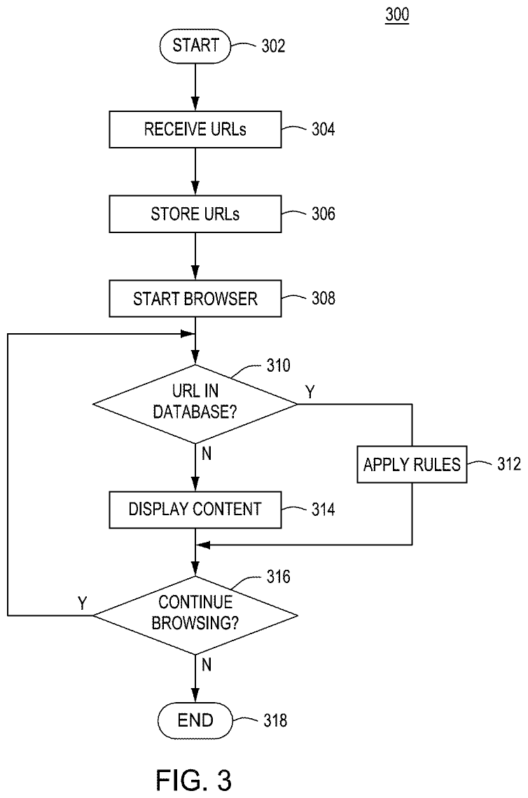

At 216, the method 200 queries whether the next webpage should be processed. If affirmatively answered, the method 200 proceeds to 204 to crawl to the next URL. The prior rendered content may be flushed from memory or written over by the next rendered content. If the query is negatively answered, the method 200 proceeds to 218 and communicates the URLs in the database to the user devices to use as described with respect to FIG. 3 below. The communication may occur by pushing the URLs to the user devices or by the user devices requesting a URL update. Alternatively, the URLs may be sent as each one is identified or may be sent on a periodic basis. The method 200 ends at 220.

FIG. 3 depicts a flow diagram of a method 300 for utilizing the detected URLs of FIG. 2 in accordance with at least one embodiment of the invention. The method 200 is partially or completely performed through execution of the URL access control application 110 in FIG. 1. The method 300 begins at 302 and proceeds to 304 where identified URLs supplied by the server 102 of FIG. 1 are received by the client URL control application 110 in FIG. 1. At 306, the URLs are stored in the user device database 112 of FIG. 1. At 308, the method 300 executes the browser. Generally, a user will launch the browser through selection of a browser icon or other application software will automatically launch the browser upon user device start up. A user will direct the browser to access content at a particular URL. Upon entry of a URL, the method 300, at 310, queries whether the URL is contained in the database. If the URL is not in the database, the content is displayed at 314 without interruption.

If the entered URL is in the database, the method 300 proceeds to 312 to apply rules regarding how to handle the URL. The most basic rule is to block access to content at the URL. Other rules may require an initial block but display a query such that a user may override the block, e.g., provide authorization. If the block function is overridden by the user, the user may be asked if the URL should be removed from the block list. If so, then the local database in the user device will be updated to remove the URL. Additional rules may be applied to the URL such as reporting that access was requested to a URL associated with malware or a virus. Such reporting can be to the user or anti-malware or anti-virus service or software. Many other rules may be applied to the URL to instruct the method 300 regarding how to handle the URL.

At 316, the method queries if browsing should continue. Generally browsing continues until the user closes the browser. If browsing continues, the method 300 proceeds to 310. If browsing ceases, the method 300 terminates at 318.

In the embodiment of FIG. 1, a centralized system 100 used web crawler to continuously crawl the internet to find URLs having undesirable content. In the embodiment of FIG. 4, a distributed system 400 uses the activity of a user operating a browser to organically develop the URLs associated with undesirable content. Consequently, as the user normally accesses web pages, the accessed content is rendered and analyzed. If undesirable content is found, the URL is added to the database of undesirable URLs.

FIG. 4 depicts a block diagram of a distributed system 400 for detecting URLs using rendered content machine learning in accordance with at least one embodiment of the invention. In FIG. 4, the system 400 comprises a server 402, user devices 406, and a computer network 404, e.g., the internet) connecting the server 402 to the user devices 406. The server 402 is a centralized computing device used to execute application(s), access databases, and perform functions to support embodiments of the invention as described herein. The general structure of such a server is described in detail below with respect to FIG. 5.

In one embodiment, the user device 406 comprises a URL detection and access control application (app) 410, a database 412, a browser 416 and rendered content 420. In some embodiments, user device 406 can be any computing device capable of hosting a URL detection and access control client application 410. User device 406 can comprise any device that is connected to a network, including, for example, a laptop, a mobile phone, a tablet computer, a desktop computer, a smart device, a router and other network devices. The browser 116 is a well known application for accessing and displaying web page content. Such browsers include, but are not limited to, Safari®, Chrome®, Explorer®, Firefox®, etc.

In operation, the user device 406 executes the application 410 to utilize a machine learning algorithm 426 for analyzing the rendered content 420. As described in detail below with respect to FIG. 5, the application 410 monitors a browser 416 as it accesses the internet 404 (e.g., access content servers such as content server 408 to access web pages 430). The application 410 renders the content of each web page 430 identified by the browser 416 to produce rendered content 420. The application 410 also temporarily stores (logs) the URL associated with the rendered content 420. The browser identifies the URL associated with the content. Such rendered content 420 may be stored in memory of the user device 406 while the content is being analyzed. The user device 406 utilizes the machine learning algorithm 426 to analyze the rendered content and determine whether the content is undesirable, e.g., should be blocked or otherwise specially handled. The details of this operation are the same as described with reference to FIG. 2, except the browser is used to initially access the web pages rather than a web crawler. As previously described, the algorithm 410 analyzes the content and determines which URL is associated with content that requires special handling, e.g., filtering. Such identified URLs may be associated with unwanted and/or malicious content that a user device should not freely access. The identified URLs 414 are stored in a database (DB) 412.

In the distributed embodiment of the invention, the identified URLs 414 are transmitted (pushed or pulled) to the server 402. The server 402 executes an application 418 that stores the URLs 424 from the user devices 406 in a database 422. Subsequently, the server application 418 communicates the URLs 424 to the various user devices 406. In this manner, the server is a repository of the undesirable URLs that are discovered by the user devices. Consequently, a database of undesirable URLs is generated through an organic process as the users interact with their browsers.

In an alternative embodiment, the user devices could utilize a web crawler to discover undesirable URLs in the same manner that the server used the crawler in FIG. 1.

The application 410 (the URL detection and access control application) may be a plug-in, script, independent, or other form of application software that interacts with the browser 416. When the browser 416 is about to access content at a URL in the database 412 the URLs 414 are handled in the same manner as described with respect to FIGS. 1 and 3.

FIG. 5 depicts a computer system 500 that can be utilized in various embodiments of the present invention to implement the computer and/or the display, according to one or more embodiments.

Various embodiments of method and system for detecting URLs using rendered content machine learning, as described herein, may be executed on one or more computer systems, which may interact with various other devices. One such computer system is computer system 500 illustrated by FIG. 5, which may in various embodiments implement any of the elements or functionality illustrated in FIGS. 1-4. In various embodiments, computer system 500 may be configured to implement methods described above. The computer system 500 may be used to implement any other system, device, element, functionality or method of the above-described embodiments. In the illustrated embodiments, computer system 500 may be configured to implement the user devices 106 and 406, server 102 and 402 and implement the methods 200 and 300 as processor-executable executable program instructions 522 (e.g., program instructions executable by processor(s) 510) in various embodiments.

In the illustrated embodiment, computer system 500 includes one or more processors 510a-510n coupled to a system memory 520 via an input/output (I/O) interface 530. Computer system 500 further includes a network interface 540 coupled to I/O interface 530, and one or more input/output devices 550, such as cursor control device 560, keyboard 570, and display(s) 580. In various embodiments, any of the components may be utilized by the system to receive user input described above. In various embodiments, a user interface may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510 may be any suitable processor capable of executing instructions. For example, in various embodiments processors 510 may be general-purpose or embedded processors implementing any of a variety of instruction set architectures (ISAs). In multiprocessor systems, each of processors 510 may commonly, but not necessarily, implement the same ISA.

System memory 520 may be configured to store program instructions 522 and/or data 532 accessible by processor 510. In various embodiments, system memory 520 may be implemented using any non-transitory computer readable media including any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via digital fiber communications networks; via storage area networks such as Fiber Channel SANs, or via any other suitable type of network and/or protocol.

Input/output devices 550 may, in some embodiments, include one or more display terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

In some embodiments, the illustrated computer system may implement any of the operations and methods described above, such as the methods illustrated by the flowchart of FIGS. 2 and 3. In other embodiments, different elements and data may be included.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine (e.g., a computing device or a “virtual machine” running on one or more computing devices). For example, a machine-readable medium may include any suitable form of volatile or non-volatile memory.

Modules, data structures, and the like defined herein are defined as such for ease of discussion and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application-programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure.

### Example Clauses

A. A method for detecting uniform resource locators (URLs) of undesirable web pages comprising:

identifying a web page having an associated URL,

rendering the content of the web page;

logging the URL associated with the web page;

applying a machine learning algorithm comprising a neural network, where the neural network analyzes the rendered content to identify undesirable attributes within the rendered content;

upon identifying undesirable content, storing the URL in a database for subsequent use by user devices to control access to the URL and its associated web page.

B. The method of clause A, wherein the identifying is performed using a web crawler.

C. The method of clauses A or B, wherein the identifying is performed using a browser.

D. The method of clauses A-C, wherein undesirable attributes of the rendered content comprise dynamic content.

E. The method of clauses A-D, wherein the database is located within a server and the server communicates the URL to a plurality of user devices.

F. The method of clauses A-E, wherein the database is located in a user device and the user device communicates the URL to a plurality of other user devices.

G. The method of clauses A-F wherein the URL is used to block content from being displayed at at least one user device.

H. The method of clauses A-G, wherein the method is performed by either a server or a user device.

I. Apparatus for detecting uniform resource locators (URLs) of undesirable web pages comprising a server or user device comprising at least one processor coupled to at least one non-transitory computer readable medium having instructions stored thereon, which, when executed by the at least one processor, cause the at least one processor to perform operations comprising:

identifying a web page having an associated URL,

rendering the content of the web page;

logging the URL associated with the web page;

applying a machine learning algorithm comprising a neural network, where the neural network analyzes the rendered content to identify undesirable attributes within the rendered content;

upon identifying undesirable content, storing the URL in a database for subsequent use by at least one user device to control access to the URL and its associated web page.

J. The apparatus of clause I, wherein the identifying is performed using a web crawler.

K. The apparatus of clauses I or J, wherein the identifying is performed using a browser.

L. The apparatus of clauses I-K, wherein undesirable attributes of the rendered content comprise dynamic content.

M. The apparatus of clauses I-L, wherein the database is located within a server and the server communicates the URL to a plurality of user devices.

N. The apparatus of clauses I-M, wherein the database is located in a user device and the user device communicates the URL to a plurality of other user devices.

O. The apparatus of clauses I-N, wherein the URL is used to block content from being displayed at least one user device.

P. A system for detecting uniform resource locators (URLs) of undesirable web pages comprising a server coupled through a computer network to a user device, where either the server or the user device comprise at least one processor coupled to at least one non-transitory computer readable medium having instructions stored thereon, which, when executed by the at least one processor, cause the at least one processor to perform operations comprising:

identifying a web page having an associated URL,

rendering the content of the web page;

logging the URL associated with the web page;

applying a machine learning algorithm comprising a neural network, where the neural network analyzes the rendered content to identify undesirable attributes within the rendered content;

upon identifying undesirable content, storing the URL in a database for subsequent use by at least one user device to control access to the URL and its associated web page.

Q. The system of clause P, wherein the identifying is performed using a web crawler.

R. The system of clause P or Q, wherein the identifying is performed using a browser.

S. The system of clauses P-R, wherein undesirable attributes of the rendered content comprise dynamic content.

T. The system of clauses P-S, wherein the database is located within the server and the server communicates the URL to a plurality of user devices.

U. The system of clauses P-T, wherein the database is located in the user device and the user device communicates the URL to a plurality of other user devices.

V. The system of clauses P-U, wherein the URL is used to block content from being displayed upon at least one user device.

1. A method for detecting uniform resource locators (URLs) of undesirable web pages comprising:
identifying a web page having an associated URL,
rendering the content of the web page;
logging the URL associated with the web page;
applying a machine learning algorithm comprising a neural network to the rendered content, where the neural network analyzes the rendered content to identify attributes within the rendered content that are considered undesirable to at least one content user, the neural network having been trained to recognize attributes within the rendered content that are considered undesirable to at least one content user; and
upon identifying undesirable content, storing the URL in a database for subsequent use by at least one user device to control access to the URL and the associated web page.

2. The method of claim 1, wherein the identifying is performed using a web crawler.

3. The method of claim 1, wherein the identifying is performed using a browser.

4. The method of claim 1, wherein attributes of the rendered content that are considered undesirable to the at least one content user comprise dynamic content.

5. The method of claim 1, wherein the database is located within a server and the server communicates the URL to a plurality of user devices.

6. The method of claim 1, wherein the database is located in a user device and the user device communicates the URL to a plurality of other user devices.

7. The method of claim 1, wherein the URL is used to block content from being displayed at the at least one user device.

8. The method of claim 1, wherein the method is performed by either a server or a user device.

9. An apparatus for detecting uniform resource locators (URLs) of undesirable web pages comprising a server or user device, comprising:
at least one processor; and
a hardware memory accessible by the processor, the memory having stored therein at least one of programs or instructions executable by the at least one processor to cause the apparatus to perform operations comprising:
identifying a web page having an associated URL,
rendering the content of the web page;
logging the URL associated with the web page;
applying a machine learning algorithm comprising a neural network to the rendered content, where the neural network analyzes the rendered content to identify attributes within the rendered content that are considered undesirable to at least one content user, the neural network having been trained to recognize attributes within the rendered content that are considered undesirable to at least one content user; and
upon identifying undesirable content, storing the URL in a database for subsequent use by at least one user device to control access to the URL and the associated web page.

10. The apparatus of claim 9, wherein the identifying is performed using a web crawler.

11. The apparatus of claim 9, wherein the identifying is performed using a browser.

12. The apparatus of claim 9, wherein attributes of the rendered content that are considered undesirable to the at least one content user comprise dynamic content.

13. The apparatus of claim 9, wherein the database is located within a server and the server communicates the URL to a plurality of user devices.

14. The apparatus of claim 9, wherein the database is located in a user device and the user device communicates the URL to a plurality of other user devices.

15. The apparatus of claim 9, wherein the URL is used to block content from being displayed at the at least one user device.

16. A system for detecting uniform resource locators (URLs) of undesirable web pages, comprising:
at least one user device;
a content server to provide content, including at least content from a web page, to the at least one user device; and
a computer network to couple the content server to the at least one user device, where at least one of the content server or the at least one user device comprise:
at least one processor; and
a hardware memory accessible by the processor, the memory having stored therein at least one of programs or instructions executable by the at least one processor to cause the at least one user device or the content server to perform operations comprising:
identifying a web page having an associated URL,
rendering the content of the web page;
logging the URL associated with the web page;
applying a machine learning algorithm comprising a neural network to the rendered content, where the neural network analyzes the rendered content to identify attributes within the rendered content that are considered undesirable to at least one content user, the neural network having been trained to recognize attributes within the rendered content that are considered undesirable to at least one content user; and
upon identifying undesirable content, storing the URL in a database for subsequent use by at least one user device to control access to the URL and the associated web page.

17. The system of claim 16, wherein the identifying is performed using a web crawler.

18. The system of claim 16, wherein the identifying is performed using a browser.

19. The system of claim 16, wherein attributes of the rendered content that are considered undesirable to the at least one content user comprise dynamic content.

20. The system of claim 16, wherein the database is located within the server and the server communicates the URL to a plurality of user devices.

21. The system of claim 16, wherein the database is located in the user device and the user device communicates the URL to a plurality of other user devices.

22. The system of claim 16, wherein the URL is used to block content from being displayed upon at least one user device.
